(19) United States
(12) Patent Application Publication
(10) Pub. No.: US 2012/0291491 A1
(43) Pub. Date: Nov. 22, 2012

(54) Method of Manufacturing Optical Component

(75) Inventors: Yuko Morita, Tokyo (JP); Hirotaka Suzuki, Tokyo (JP)

(73) Assignee: Olympus Corporation, Tokyo (JP)

(21) Appl. No.: 13/559,847

(22) Filed: Jul. 27, 2012

Related U.S. Application Data
(63) Continuation of application No. PCT/JP2011/051187, filed on Jan. 24, 2011.

(30) Foreign Application Priority Data
Jan. 28, 2010 (JP) 2010-017363

(51) Int. Cl. C03B 32/00; C03C 17/00

(52) U.S. Cl. 65/32.4; 65/60.1

(57) ABSTRACT

The method of manufacturing an optical component includes: a process for forming optical surface of mirror-finishing a surface of an object-to-be-processed that is formed of glass; a heating process of heating the object-to-be-processed that is mirror-finished; and a film forming process of forming an optical thin film on the surface of the object-to-be-processed that is heated in the heating process. In the heating process, a temperature of the object-to-be-processed is from 0.75 times or more to 1 times or less of a glass transition point T_{g} (K) of the object-to-be-processed.

This application is a continuation application based on a PCT Patent Application No. PCT/JP2011/051187, filed Jan. 24, 2011, whose priority is claimed on Japanese Patent Application No. 2010-017363, filed Jan. 28, 2010. The contents of both the PCT Application and the Japanese Application are incorporated herein by reference.

### TECHNICAL FIELD

The present invention relates to a method of manufacturing optical components. Specifically, the present invention relates to a method of manufacturing an optical component in which for example, a thin film formed of an oxide, a boride, metal, or the like is formed on a surface of a glass material, among optical components such as a filter, a prism, and a lens, which are used as elements of various optical devices including a microscope, a camera, an endoscope, and the like.

### BACKGROUND ART

Conventionally, for example, optical components such as a filter, a prism, and a lens, which are formed of glass, have been manufactured by a method in which glass having an approximate shape of the optical components is ground and polished, or a method of molding the optical components using a heated mold.

In these optical components, an optical thin film, which controls reflection properties and transmission properties of a mirror surface, is frequently formed on an optical mirror surface that is mirror-finished. This optical thin film is configured by forming a metallic oxide, a fluoride thin film, a metallic film, or the like of several nm to several hundred nm on the optical mirror surface in a single layer or a multi-layer. A film configuration of the optical thin film is determined by an optical thin film simulation to obtain desired optical properties such as a spectral reflectance property, a spectral transmittance property, and the like. The film design by the optical thin film simulation is performed using a film refractive index, a film thickness, and the number of layers as parameters after setting a refractive index of glass that is used as a base of the optical component. In addition, in a film forming process, research to prevent a film from being peeled off by adjusting film-forming conditions to adjust film stress has been performed.

However, in an actual manufacturing process, film defects in which the peeling-off of the film, the spectral reflectance properties, or the spectral transmittance properties is not consistent with the design may occur depending on the optical component.

The defects may be considered to be because a processing-modified layer is formed on a surface of the optical component after mirror-finishing due to any cause.

As a technology of removing the processing-modified layer formed on the optical mirror surface, Japanese Unexamined Patent Application, First Publication No. 2002-82211 in the related art discloses a method of manufacturing an optical element. This method includes a first step of processing a substrate formed of CaF₂ single crystal, a second step of removing contaminants from the surface of the substrate after the process of the first step, and a third step of removing a processing-modified layer on the surface of the substrate after the process of the second step.

In the method disclosed in Japanese Unexamined Patent Application, First Publication No. 2002-82211, the processing-modified layer on the surface of the CaF₂ substrate after processing is removed by etching the processing-modified layer by water or a water-based cleaning solution.

Here, as disclosed in Japanese Unexamined Patent Application, First Publication No. 2002-82211, the processing-modified layer in Japanese Unexamined Patent Application, First Publication No. 2002-82211 “may be a processing-modified layer formed in a minuscule region in the vicinity of a surface by processing in polishing processing. This processing-modified layer may serve as an absorption layer with respect to light of a short wavelength such as ultraviolet rays.” Therefore, the processing-modified layer may be etched and removed using water or a water-based cleaning solution containing a surfactant.

### SUMMARY OF INVENTION

According to a first aspect of the present invention, there is provided a method of manufacturing an optical component. This method includes a process for forming optical surface of mirror-finishing a surface of an object-to-be-processed that is formed of glass, a heating process of heating the object-to-be-processed that is mirror-finished, a film forming process of forming an optical thin film on the surface of the object-to-be-processed that is heated in the heating process, and a cleaning process of cleaning the object-to-be-processed by a water-based cleaning solution between the process for forming optical surface and the heating process. In the heating process, a first temperature of the object-to-be-processed is from 0.75 times or more to 1 times or less of a glass transition point T_{g} (K) of the object-to-be-processed.

Here, the water-based cleaning solution represents a water-containing cleaning solution in which for example, a surfactant or the like is dissolved in water, or a cleaning solution including only water.

According to a second aspect of the present invention, in the method of manufacturing the optical component of the first aspect, in the heating process, in the heating process, the object-to-be-processed may be heated so that the first temperature of the object-to-be-processed is higher than a second temperature of the object-to-be-processed in the film forming process.

According to a third aspect of the present invention, in the method of manufacturing the optical component of the first aspect or the second aspect, in the heating process, the object-to-be-processed may be heated in vacuum.

Here, the vacuum represents, for example, from 10⁻⁶ Pa or more to 5×10² Pa or less.

According to a fourth aspect of the present invention, in the method of manufacturing the optical component of the first aspect or the second aspect, in the heating process, the object-to-be-processed may be heated in inert gas.

According to a fifth aspect of the present invention, in the method of manufacturing the optical component of the fourth aspect, the inert gas may be helium.

According to a sixth aspect of the present invention, in the method of manufacturing the optical component of the first aspect or the second aspect, the heating process may be performed in a heating chamber that is provided separately from a film forming chamber in which the film forming process is performed.

According to a seventh aspect of the present invention, in the method of manufacturing the optical component of the first aspect or the second aspect, the object-to-be-processed may be an optical glass containing at least fluorine.

According to an eighth aspect of the present invention, in the method of manufacturing the optical component of the first aspect or the second aspect, the object-to-be-processed may be an optical glass containing at least phosphorus.

According to a ninth aspect of the present invention, in the method of manufacturing the optical component of the first aspect or the second aspect, the object-to-be-processed may be an optical glass containing at least bismuth.

### BRIEF DESCRIPTION OF DRAWINGS

FIG. 1 is a cross-sectional view that is taken along an optical axis direction and illustrates an example of an optical component manufactured by a method of manufacturing an optical component according to a first embodiment of the present invention.

FIG. 2 is a flowchart illustrating processes of the method of manufacturing the optical component according to the first embodiment of the present invention.

FIG. 3 is a schematic process explanatory view of an object-to-be-processed manufacturing process, a process for forming optical surface, a cleaning process, and a heating process of the method of manufacturing the optical component according to the first embodiment of the present invention.

FIG. 4 is a flowchart illustrating processes of methods of manufacturing an optical component according a modified example of the first embodiment of the present invention and a second embodiment of the present invention.

### DESCRIPTION OF EMBODIMENTS

Hereinafter, a method of manufacturing an optical component according to embodiments of the present invention will be described with reference to the attached drawings.

### First Embodiment

A description will be made with respect to a method of manufacturing an optical component according to a first embodiment of the present invention.

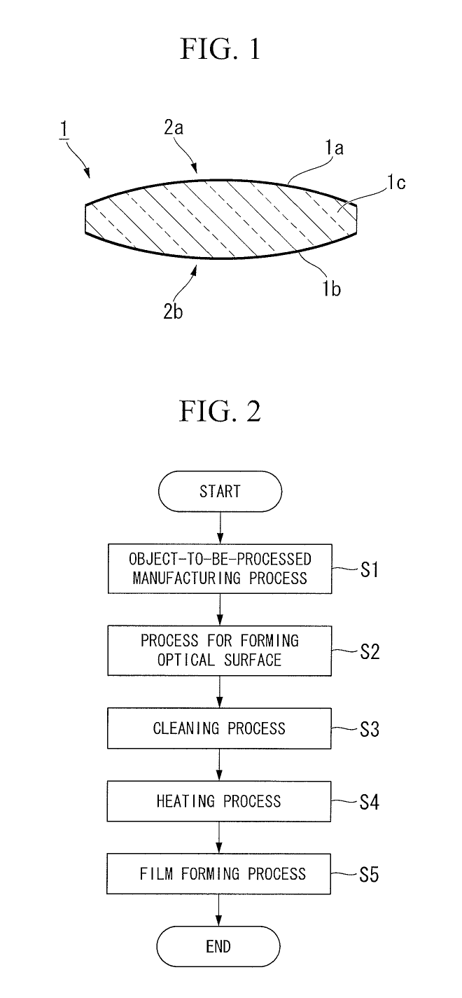

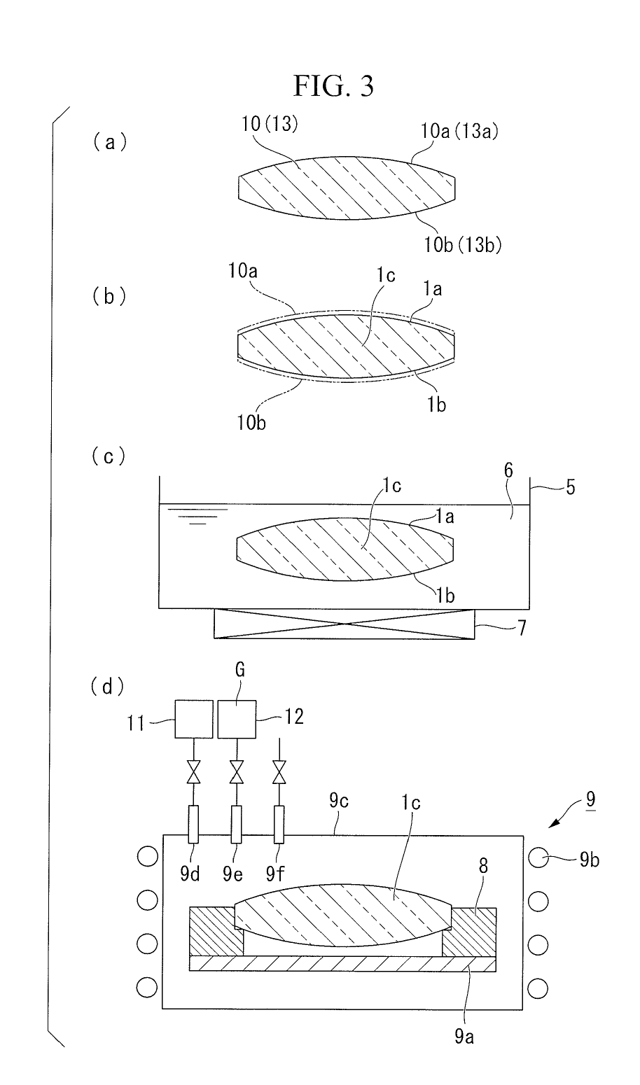

FIG. 1 shows a cross-sectional view that is taken along an optical axis direction and illustrates an example of the optical component manufactured by the method of manufacturing the optical component according to the first embodiment of the present invention. FIG. 2 shows a flowchart illustrating a process flow of the method of manufacturing the optical component according to the first embodiment of the present invention. Sections (a), (b), (c), and (d) of FIG. 3 show schematic process explanatory views of an object-to-be-processed manufacturing process, a process for forming optical surface, a cleaning process, and a heating process of the method of manufacturing the optical component according to the first embodiment of the present invention, respectively.

The method of manufacturing the optical component of this embodiment is a method of manufacturing an optical component in which an optical thin film is formed on a glass surface.

A kind of the optical component is not particularly limited as long as the optical component is formed of glass and an optical thin film is formed on a surface thereof. For example, a flat glass substrate, a lens, an optical filter, a reflective mirror, a prism, and the like may be exemplified. In any of these optical elements, an optical surface that transmits or reflects light is formed with high accuracy by mirror-finishing, and on a surface of the optical surface, an optical thin film of a single layer or a multi-layer is formed.

As a surface shape of the optical surface, a desired shape, for example, a flat surface, a spherical surface, a non-spherical surface, a free-form surface, or the like may be adopted. In addition, as a method of forming an optical surface of a lens, grinding and polishing may be adopted.

In addition, as a kind of the optical thin film, an optical thin film such as a surface protective film, an antireflection film, a reflective film, a wavelength filter film, a polarization separation film, and the like that have various functions may be exemplified.

Hereinafter, a description will be made with respect to the case of manufacturing a lens 1 shown in FIG. 1 as an example of the optical component.

The lens 1 is a double-convex lens that has lens surfaces 1a and 1b having a surface shape of a convex spherical surface as an optical surface on surfaces of a lens main body 1c, respectively. Optical thin films 2a and 2b are formed on effective surface of lens on the lens surfaces 1a and 1b so as to preferably transmit light of a design wavelength and suppress surface reflection.

In a method of manufacturing the optical component of this embodiment, as shown in FIG. 2, the lens 1 is manufactured by performing an object-to-be-processed manufacturing process S1, a process for forming optical surface S2, a cleaning process S3, a heating process S4, and a film forming process S5 in this order.

As shown in a section (a) of FIG. 3, the object-to-be-processed manufacturing process S1 is a process of manufacturing an object-to-be-processed 10 having a shape in which the lens main body 1c of the lens 1 is made to be slightly thick in an optical axis direction.

That is, the object-to-be-processed 10 has convex spherical surfaces 10a and 10b having a radius of curvature that is substantially the same as that of the lens surfaces 1a and 1b. An inter-surface distance on the central axis between the convex spherical surface 10a and 10b is slightly longer than an inter-surface distance on the optical axis between the lens surfaces 1a and 1b of the lens 1.

When the object-to-be-processed 10 is manufactured, first, a circular plate that is slightly thicker than the lens 1 is cut from a glass base material, and grinding of a circumferential surface of this circular plate or the like is performed and thereby firstly, lens side surfaces are formed.

Next, the convex spherical surfaces 10a and 10b, which have a spherical center position on a central axis with the lens side surfaces made as a reference, are formed, respectively. The convex spherical surfaces 10a and 10b are processed by sequentially performing, for example, cutting, rough grinding, fine grinding, and the like in such a manner that surface accuracy is raised step by step to surface accuracy with which preferable grinding may be performed. Finally, an inter-surface distance is obtained with an appropriate grinding allowance being left.

When this processing is terminated, the object-to-be-processed 10 that is obtained is appropriately cleaned.

Then, the object-to-be-processed manufacturing process S1 is terminated.

As a material of the glass base material of the object-to-be-processed 10, a glass material of the optical glass, which is appropriate in response to optical properties (a refractive index and Abbe number) that are necessary for the lens 1, is selected.

In recent years, various glass materials, which have been developed so as to provide, for example, a low dispersion property, an abnormal dispersion property, a high refractive index, a low melting point, or the like, may have necessarily been used to promote performance improvement such as miniaturization and high performance of a lens. However, among these glass materials, there is a glass material in which chemical durability is less with respect to water or water-based cleaning solution containing water due to an element composition.

The method of manufacturing the optical component of this embodiment is a method that is appropriate to a case where a material in which chemical durability is less with respect to the water or water-based cleaning solution containing water, for example, a glass material such as phosphate glass, fluorophosphate glass, and bismuth-containing glass is used.

The phosphate glass, fluorophosphate glass, and bismuth-containing glass have small Knoop hardness representing glass strength, and have less water resistance, acid resistance, or detergent resistance that represents chemical durability of glass. This is caused by properties of phosphoric acid, a fluoride, bismuth, or the like that is contained in glass.

As an example of this glass material, fluorophosphate glass such as FCD1, FCD10 (the aforementioned are manufactured by HOYA Corporation), S-FPL51, 53 (the aforementioned are manufactured by OHARA Inc.), K-CaFK95, K-PFK80, and K-PFK85 (the aforementioned are manufactured by SUMITA OPTICAL GLASS, Inc.), Bi-containing glass such as K-PSFn1, K-PSFn2, K-PSFn3, K-PSFn4, K-PSFn5 (the aforementioned are manufactured by SUMITA OPTICAL GLASS, Inc.), and L-BBH1 (manufactured by OHARA Inc.), or the like may be exemplified.

Next, process for forming optical surface S2 is performed.

In this process, as shown in a section (b) of FIG. 3, the surface of the object-to-be-processed 10 is mirror-finished to form an optical mirror surface of the lens surfaces 1a and 1b. In this embodiment, as the mirror-finishing, polishing is adopted. In this process, the object-to-be-processed 10 is held by a polishing device (not shown). The convex spherical surface 10a is polished by using, for example, a polishing plate corresponding to the lens surface 1a while supplying an appropriate polishing agent to form the lens surface 1a. Next, the object-to-be-processed 10 is held by the polishing device in an inverted manner, and the convex spherical surface 1b is polished by using, for example, a polishing plate corresponding to the lens surface 10b while supplying an appropriate polishing agent to form the lens surface 1b.

As the polishing agent, a polishing agent, which is obtained by dispersing an abrasive including particulate abrasive grains, for example, a zirconium oxide, a cerium oxide, or the like in a water-based polishing solution, may be adopted. By this process for forming optical surface S2, the lens main body 1c having the lens surfaces 1a and 1b is formed from the object-to-be-processed 10.

Then, the process for forming optical surface S2 is terminated.

The lens main body 1c after being polished is detached from the polishing device before being subjected to the next cleaning process S3 and a process of wiping a surface is performed. Therefore, the mirror surface formed by the polishing comes into contact with water contained in the polishing solution from a point of time when being separated from a polishing tool such as the polishing plate until the surface wiping process is terminated.

In addition, since the cleaning process S3 is performed, the lens main body 1c comes into contact with moisture in an air atmosphere while being stored at the outside of the polishing device or being moved to a cleaning bath.

Next, the cleaning process S3 is performed.

This process is a process of cleaning the lens main body 1c by a water-based cleaning solution 6 to which water or a water-based surfactant is added as shown in a section (c) of FIG. 3, after performing the process for forming optical surface S2 and after the lens main body 1c is subjected to cleaning through an oil removing bath, an emulsified cleaning solution bath, or the like if necessary.

In the cleaning process S3 of this embodiment, at the time of the cleaning using the water-based cleaning solution 6, the cleaning bath 5 provided with an ultrasonic vibrator 7 is filled with the water-based cleaning solution 6, and the lens main body 1c is dipped in the water-based cleaning solution 6 and is ultrasonic-cleaned for a constant time.

In this process, it is preferable that the cleaning be performed in multi-stages by changing the kind of the water-based cleaning solution 6, and pure water be used as the water-based cleaning solution 6 in the final cleaning. Cleaning times at each cleaning stage may be the same as each other or may be different from each other.

For example, after the lens main body 1c is dipped in one or more cleaning baths filled with a neutral or weak alkaline water-based cleaning solution including a surfactant as the water-based cleaning solution 6 and the ultrasonic cleaning is performed. Next, preferably, the lens main body 1c is taken out and is dipped in one or more cleaning baths 5 that are pure-water rinsing baths filled with pure water as the water-based cleaning solution 6, and then the ultrasonic cleaning is performed.

As the neutral water-based cleaning solution 6 including a surfactant, for example, a cleaning solution (pH 7.5) containing 0.5% of a non-ionic activating agent including a polyoxyethylene chain, or the like may be adopted.

The lens main body 1c taken out from the final cleaning bath 5 is quickly subjected to a draining process, a drying process, or the like to remove moisture on a surface thereof.

Then, the cleaning process S3 is terminated.

Next, the heating process S4 is performed.

As shown in a section (d) of FIG. 3, this process is a process of heating the lens main body 1c (an object to be processed after the mirror-finishing) in which the lens surfaces 1a and 1b are formed by the process for forming optical surface S2.

In addition, the heating process S4 of this embodiment is a process of heating the lens main body 1c after the optical mirror surfaces formed by the process for forming optical surface S2 come into contact with water or moisture due to the polishing using the polishing solution containing water in the process for forming optical surface S2 and the cleaning process S3 performed after the process for forming optical surface S2.

First, the lens main body 1c is held by a heat-resistant lens holder 8, and is installed on a heating stage 9a that supports the lens holder 8 in a heating device 9 including, for example, an electric furnace.

As the heating device 9, a heating mechanism inside a film-forming chamber, which forms a film, of a film-forming device to be described later may be used, and a separate device may be used. In this embodiment, a description will be made with respect to a case of a separate device being used as an example.

The heating device 9 that is used in this embodiment includes a heating stage 9a, a heating bath 9c (heating chamber) that accommodates the lens holder 8 on the heating stage 9a in a hermetically closed state, and a heating portion 9b that heats the inside of the heating bath 9c.

In addition, the heating bath 9c includes a suction port 9d that suctions air inside the heating bath 9c so as to adjust the atmosphere inside the heating bath 9c, an inert gas supplying port 9e that introduces inert gas G into the heating bath 9c, and an air introducing port 9f that introduces air into the heating bath 9c. An on-off valve is provided in the suction port 9d, the inert gas supplying port 9e, and the air introducing port 9f, respectively.

In addition, a vacuum pump 11, which suctions air from the suction port 9d, is connected to the suction port 9d, and an inert gas supplying portion 12, which supplies the inert gas G, is connected to the inert gas supplying port 9e.

As the inert gas G, for example, inert gas such as nitrogen, helium, and argon may be adopted.

Next, any of the suction port 9d, the inert gas supplying port 9e, and the air introducing port 9f is opened, and either the vacuum pump 11 or the inert gas supplying portion 12 is made to operate according to necessity, and thereby the atmosphere inside the heating bath 9c is adjusted to any one of a vacuum atmosphere, an inert gas G atmosphere, and an air atmosphere.

In addition, the inside of the heating bath 9c is heated by the heating portion 9b, and thereby the lens main body 1c is heated from room temperature to a treatment temperature T (K). In addition, the treatment temperature T(K) is held for a constant holding time t and then the temperature of the lens main body 1c is lowered to a cooling temperature T_{C} (T_{C}<T).

Here, the treatment temperature T(K) (first temperature) is set to be from 0.75 times or more to 1 times or less of a glass transition point T_{g}(K) of the glass material, and to be higher than a temperature (second temperature) of the lens main body 1c in the film forming process S5 to be described later.

In addition, the cooling temperature T_{C} is set to be lower than a film forming temperature T_{g} in the film forming process S5 described below, and to be a temperature at which a moving unit or moving tool that moves the lens main body 1c to the film forming device has durability when being used.

Then, the heating process S4 is terminated.

The lens main body 1c after being subjected to the heating process S4 is conveyed to a film forming device along an appropriate conveying path. At this time, the film forming device conveys the lens main body 1c in a protective manner in order for the surface of the lens main body 1c not to be contaminated, and the film forming device conveys the lens main body 1c in order for the lens main body 1c not to come into contact with air in which humidity is high. To accomplish the above-described conditions, for example, the inside of the conveying path is cleaned and set to a dehumidified atmosphere, or the lens main body 1c is conveyed with being accommodated in a conveying case having an excellent hermetical property.

As is the case with this embodiment, when the heating device 9 is provided separately from the film forming device, the heating atmosphere, the heating temperature, the heating time, or the like may be set without being restricted by a configuration of the film forming device, and therefore there is an advantage in that the degree of freedom of process-setting increases.

For example, in a general film forming device, a plurality of lenses are set in a film forming dome during forming a film, and the film forming is performed while rotating the plurality of lenses. At this time, to decrease a film thickness distribution in the film forming dome, a movable portion that rotates the film forming dome is provided in the film forming device. This movable portion is formed with a device design that is capable of withstanding a temperature region of 200° C. to 300° C. at the time of forming a film, but may not have durability in a temperature region near the glass transition point T_{g} of the glass base material, which is a high temperature.

In this case, as is the case with this embodiment, a method, in which the heating process S4 is performed with respect to the lens main body 1c by the heating device 9 provided separately from the film forming device, and then the lens main body 1c is made to move within the film forming device to form a film, is effective.

In addition, so as to reduce an amount of movement from the heating device 9 to the film forming device, it is preferable that the heating device 9 be disposed to be adjacent to the film forming device.

Furthermore, even in a case in which the heating device 9 is provided integrally with the film forming device, it is preferable that the heating device 9 be provided to be adjacent to the film forming chamber, which forms a film, in the film forming device, as a heating chamber in which atmosphere different from that inside of the film forming chamber, and a heating temperature and a heating time different from that of the film forming chamber may be freely set. Furthermore, it is preferable to provide a conveying mechanism that conveys the lens main body 1c after being subjected to the heating process S4 from the heating chamber to the film forming chamber by an operation from the outside. According to this configuration, it is not necessary to occupy the film forming chamber when performing the heating process S4, and the atmosphere or heating temperature of the heating chamber, or the heating time may be freely set. Furthermore, contamination of the optical mirror surface or attachment of moisture to the optical mirror surface before forming the film may be prevented in a relatively easy manner during a conveying stage from the heating chamber to the film forming chamber.

Next, the film forming process S5 is performed. This process is a process of forming the optical thin films 2a and 2b on the lens surfaces 1a and 1b that are surfaces of the lens main body 1c after being heated by the heating process S4.

As the film forming device, although not particularly illustrated, a well-known film forming device, for example, a vacuum deposition device or the like may be adopted in response to a film configuration of the optical thin films 2a and 2b.

First, the lens main body 1c conveyed into the film forming device is provided in the film forming chamber of the film forming device in such a manner that either the lens surface 1a or 1b on which a film is desired to be formed, for example, the lens surface 1a faces downwardly. At a lower side of the lens main body 1c, an oxide or fluoride serving as a film material is placed in a heating dish and this heating dish is spaced from the lens main body 1c by several tens of centimeters.

Next, the film forming chamber is evacuated. After being evacuated, the film material is heated and melted. As a method of melting the film material, a method of heating the heating dish, a method of directly heating the film material by electron beams or ion sputtering, or the like may be appropriately adopted.

In the film material that is heated and melted, molecules of the film material are vaporized and are scattered to the surface of the lens surface 1a. When these molecules are deposited on the surface of the lens surface 1a and form a layer, the optical thin film 2a is formed. At this time, the lens main body 1c is heated in advance in the film forming device using the heating mechanism embedded in the film forming device so that the lens surface 1a gets to the film forming temperature T_{S}. In this manner, energy loss of the scattered molecules on the surface of the lens surface 1a may be reduced, such that adhesiveness between the optical thin film 2a and the surface of the lens surface 1a may be preferably improved.

The film forming temperature T_{S} is appropriately set in response to the heating temperature of the film material.

When the optical thin film 2a is formed, the lens main body 1c is inverted, and the optical thin film 2b is formed on the lens surface 1b in a manner as described above.

When the film formation is terminated, the film forming device is opened and the completed lens 1 is carried out to the outside of the film forming device.

In this manner, the lens 1 shown FIG. 1 may be manufactured according to the method of manufacturing the optical component of this embodiment.

Next, an operation of the method of manufacturing the optical component of this embodiment will be described.

In the process of manufacturing the optical component in which the optical thin film is formed on the glass surface, adhesion strength of the optical thin film, spectral reflectance properties or spectral transmittance properties may not be obtained according to design plan depending on optical components, and therefore a film defect such as peeling-off of the optical thin film, a defect in the optical properties of the optical thin film, or the like may occur.

The present inventors performed various investigations with respect to a cause of this film defect, and found that the film defect is caused by a fact that optical properties (a refractive index, a scattering property) or fracture strength of a surface portion varies through a processing process or a cleaning process after being processed when compared to original properties of base glass.

In the optical glass, a glass network forming component such as silica is difficult to elute into water or a water-based cleaning solution. Conversely, components such as Na—O, K—O—, and —O—Ba—O—, which are called glass modifying components, are easily eluted into the water or water-based cleaning solution. Therefore, a deviation in an elution property is present for each of elements that make up glass. As a result, on the surface of glass, which comes into contact with the water or water-based cleaning solution, segregation such as compositional inclination occurs easily, and due to this segregation, a composition in the surface of the optical glass varies, and the optical properties or physical properties, which the optical glass originally has, varies.

When the polishing is performed using the polishing solution containing water like the process for forming optical surface S2 of this embodiment, even after the optical mirror surface is formed, a state in which the optical mirror surface and water come into contact with each other continues until water is wiped away. In addition, it is necessary to perform the cleaning process S3 so as to remove the abrasive or the like that is attached onto the optical mirror surface. Therefore, it is unavoidable that the formed optical mirror surface comes into contact with water. In this process, a contact type or a contact time becomes different, and the degree of modification of the optical mirror surface becomes different depending on pH of a water-containing solution, co-existing components in the solution such as a surfactant, and whether or not ultrasonic waves are present during being immersed in liquid, but any contact with water becomes a cause of the surface modification of the optical component.

Therefore, the present inventors researched whether or not the modified layer that is formed due to the contact with water may be restored, and they found that the modified layer is restored by performing the heating process S4 as described above after the modified layer and water come into contact with each other, and they accomplished the present invention.

With respect to properties of the modified layer that is formed by contact with water and an operation of restoring the modified layer through the heating process S4, the present inventors assumed as described below from the result of observing various analysis results.

At the glass surface portion that comes into contact with water, an ion-exchange reaction occurs between a hydronium ion (H₃O⁺) and an alkali metal ion such as Na (sodium) and K (potassium) or an alkali earth metal ion such as Ca (calcium), Mg (magnesium), and Ba (barium) in water depending on components of the glass.

Therefore, metal ions that are eluted into water segregate onto the glass surface. In addition, water on the glass surface shows alkalinity, and thereby cutting of glass skeleton and segregation of the glass components further progress.

In this way, the glass skeleton is cut or the glass component is leaked due to the contact with water, and therefore a modified layer, which is modified to a less dense structure compared to an original glass surface, is formed.

In this modified layer, the longer the contact time with water, the further the elution of the glass component progresses. Therefore, the thickness of the modified layer becomes larger. That is, in the modified layer, the cutting of the glass skeleton or the leakage of the glass component progresses further, and thereby the modified layer becomes a porous layer in which fine holes (pores) of angstrom to nanometer level are generated. In this porous layer, a decrease in refractive index or a decrease in strength becomes significant, and therefore the change of the optical property of the optical thin film, or a film defect such as the peeling-off of the optical thin film occurs easily. Since in the modified layer, the microstructure of the surface varies in this way, the modified layer has a refractive index different from a refractive index which glass originally has.

In the heating process S4 of this embodiment, this modified layer is heated at a temperature close to the glass transition point T_{g} of the glass base material. Therefore, it is assumed that re-coupling of the glass skeleton occurs by thermal energy that is applied to the modified layer, or the less dense portion from which the glass component is leaked may become dense, and thereby the modified layer may be improved.

In this manner, since the fine holes of the modified layer are shrunk, and thereby the modified layer is restored to a state that is close to the microstructure before the surface modified layer is formed, the refractive index and strength can be nearly improved to the state before the modified layer is formed.

In a case where the cleaning process S3 in which the contact time between the lens main body 1c and water is particularly lengthened (this is because the water or water-based cleaning solution containing water is used) is used, when the heating process S4 is performed after the cleaning process S3, the modified layer that is deeply formed may be restored. Therefore, the heating process S4 of this embodiment is particularly effective.

In addition, it is not necessary to perform the heating process until all of the fine holes in the modified layer are removed, and the heating process may be performed to a state in which the peeling-off of the optical thin film does not occur or an adverse effect is not applied to the optical property of the thin film.

In addition, the lower a resistance to water, an acid, or an alkali the glass has, the larger the thickness of the modified layer becomes. Therefore, in a case where optical glass contains at least one selected from fluorine, phosphorus, and Bi (bismuth), the present embodiment is particularly effective.

A particularly preferable range of the treatment temperature T (K) in the heating process S4 is from 0.75 times or more to 1 times or less of the glass transition point T_{g} (K).

When the treatment temperature T(K) is less than 0.75 times the glass transition point T_{g} (K), thermal energy that is supplied to the modified layer becomes insufficient, and therefore the pores in the porous layer of the modified layer may not be shrunk to be sufficiently small. Therefore, the improvement in the surface strength of the lens surfaces 1a and 1b and the refractive index becomes insufficient, and the peeling-off the film after film formation, the spectral reflectance defect, or the like may easily occur. As a result, a yield ratio of the lens 1 is deteriorated.

In addition, at temperatures at which the treatment temperature T (K) exceeds the one times the glass transition point T_{g} (K), the shape of the surface portion of the optical component may vary. Therefore, this serves as a cause of lowering surface accuracy.

In addition, in this embodiment, the treatment temperature T at the heating process S4 is set to be higher than the film forming temperature T_{S} in the film forming process S5.

Therefore, even when the densification of the modified layer in the heating process S4 is incomplete and therefore the modified layer remains, since the remaining modified layer is a layer that is not densified at a high temperature state, a probability of the modified layer being densified by being heated at a low film-forming temperature T_{S} in the film forming process S5 is lower.

Conversely, when the film forming temperature T_{S} is set to be higher than the treatment temperature T, since the film forming temperature T_{S} in the film forming process S5 is higher than the treatment temperature T, the modified layer, which remains without being restored at the treatment temperature T in the heating process S4, receives thermal energy larger than that at the treatment temperature T. As a result, the modified layer that is a porous layer is densified at the time of forming a film, and therefore the pores in the porous layer are shrunk. Therefore, since deformation in the microstructure of the optical mirror surface progresses together with the film formation, the film strength of the optical thin films 2a and 2b becomes weak, and therefore a defect such as cracking or peeling-off of the optical thin film may easily occur.

In addition, the atmosphere inside the heating device 9 in the heating process S4 may be appropriately selected depending on the degree of restoring of the modified layer or the like according to necessity.

For example, in a case where the heating process S4 is performed with an atmosphere inside the heating device 9 set to an air atmosphere, when the pores in the porous layer of the modified layer are shrunk, the shrinkage progresses from a thin portion having a bottle-neck shape. As a result, the hole is closed at an intermediate portion in the thickness direction of the modified layer and thereby a hole in which air is confined may remain. Therefore, the restoring of the microstructure may not progress from this structure state.

In this case, when the heating process S4 is performed in a state in which the inside of the heating device 9 is evacuated, since the air in the pores is removed in advance, the shrinkage of the modified layer is sufficiently performed while the confinement of gas in the microstructure of the modified layer does not occur. As a result, the degree of restoring of the modified layer may be improved. That is, since the pores are shrunk to be smaller compared to a case in which the heating is performed in the air atmosphere, a microstructure of the modified layer having a refractive index and strength that are close to that of the base glass may be obtained.

In addition, by performing the heating process S4 in a vacuum atmosphere, oxidative deterioration of a metal member inside the heating device 9 or a metal member that is used for the lens holder 8 or the like may be prevented.

As is the case with the heating in a vacuum state, when the heating process S4 is performed with the atmosphere inside the heating device 9 set to an inert gas G atmosphere, the oxidative deterioration of the metal member inside the heating device 9 or the metal member that is used for the lens holder 8 or the like may be prevented.

Furthermore, in a case where helium is used as the inert gas G, the air molecules (oxygen or nitrogen) that are present in the pores are substituted with helium having a molecular size smaller than that of the air molecules. Therefore, even in a state in which the neck of the pores is shrunk, since the molecular size is small, the air molecules may escape, and therefore the confinement of gas does not easily occur. As a result, a microstructure of the modified layer having a refractive index and strength that are close to that of the base glass may be obtained.

Next, specific operations of the method of manufacturing the optical component of this embodiment will be described on the basis of Examples 1 to 4.

Manufacturing conditions in each Example are collectively shown in Table 1 described below.

TABLE 1

| Conditions | | Example 1 | Example 2 | Example 3 | Example 4 | Example 5 | Example 6 |
|---|---|---|---|---|---|---|---|
| Glass | Material | Fluorophosphate | Fluorophosphate | Fluorophosphate | Fluorophosphate | Bismuth-based | Si—Ba-based |
| material | | glass | glass | glass | glass | glass | glass |
| | Refractive | 1.43875 | 1.43875 | 1.43875 | 1.43875 | 2.10205 | 1.60311 |
| | index | | | | | | |
| | Abbe number | 94.9 | 94.9 | 94.9 | 94.9 | 16.6 | 60.7 |
| | Glass | 699 | 699 | 699 | 699 | 623 | 936 |
| | transition | | | | | | |
| | point T_{g} (K) | | | | | | |
| Shape of optical | | Double-convex | Biconcave | Parallel | Parallel | Double-convex | Meniscus |
| component | | lens | lens | plate | plate | lens | lens |
| Abrasive | | Zirconium | Zirconium | Zirconium | Zirconium | Zirconium | Diamond |
| | | oxide-based | oxide-based | oxide-based | oxide-based | oxide-based | |
| Cleaning | Water-based | pH 7.5, three | pH 7.5, three | pH 7.5, three | pH 7.5, three | pH 8.3, two | — |
| conditions | cleaning | baths | baths | baths | baths | baths | |
| | solution (pH, | | | | | | |
| | number of | | | | | | |
| | baths) | | | | | | |
| | Pure water | Three baths | Three baths | Three baths | Three baths | Two baths | — |
| | (number of | | | | | | |
| | baths) | | | | | | |
| | Cleaning time | 60 | 60 | 60 | 60 | 60 | — |
| | (second/bath) | | | | | | |
| Heating | Treatment | 349 to 839 | 349 to 839 | 349 to 839 | 349 to 839 | 312 to 748 | 468 to 1123 |
| conditions | temperature | | | | | | |
| | T(K) | | | | | | |
| | T/T_{g} | 0.50 to 1.2 | 0.50 to 1.2 | 0.50 to 1.2 | 0.50 to 1.2 | 0.50 to 1.2 | 0.50 to 1.2 |
| | Holding time t | 1 | 1 | 1 | 1 | 1 | 1 |
| | (h) | | | | | | |
| | Atmosphere | Air | Vacuum | Nitrogen | Helium | Air | Air |
| Optical | Number of | 7 | 7 | 7 | 7 | 6 | 7 |
| thin | layers | | | | | | |
| film | Film forming | 513 | 513 | 513 | 513 | 473 | 513 |
| | temperature Ts | | | | | | |
| | (K) | | | | | | |

### Example 1

In Example 1, an object-to-be-processed of a double-convex lens, which has a radius of curvature of 30 mm, a diameter of 45 mm, and a central thickness of 35 mm, was manufactured from fluorophosphate glass (T_{g}=699(K) (=426° C.)) which contains fluorine and phosphorus and in which a refractive index is 1.43875 and Abbe number is 94.9 as a glass material (an object-to-be-processed manufacturing process S1).

Next, in the process for forming optical surface S2, the object-to-be-processed was polished using a water-based polishing solution including zirconium oxide-based ZOX-N (a registered trademark) as an abrasive to form an optical mirror surface, and then moisture on a surface was wiped away.

Next, in the cleaning process S3, the object-to-be-processed after being polished was cleaned using a multi-bath type ultrasonic cleaning machine. A multi-bath type cleaning bath includes six baths of oil removing baths, an emulsified cleaning solution bath, and the cleaning bath 5, and the cleaning bath 5 further includes three baths of water-based cleaning baths and a rinsing bath. In the cleaning process S3, the object-to-be-processed was made to pass through the oil removing baths and then was made to pass through the emulsified cleaning solution bath. Then, the object-to-be-processed was made to pass through the three baths of water-based cleaning baths and the rinsing bath of the cleaning bath 5.

In the water-based cleaning bath, a water-based cleaning solution (pH 7.5), which contained 0.5% of a non-ionic activating agent including a polyoxyethylene chain, was used as the water-based cleaning solution 6. In addition, in the rinsing bath, pure water was used.

In addition, in each of the cleaning baths 5, ultrasonic cleaning at an ultrasonic frequency of 40 kHz was performed for 60 seconds for each bath by using the ultrasonic vibrator 7.

Next, in the heating process S4, after the object-to-be-processed after the cleaning process was dried, the object-to-be-processed was put into an electric furnace that is the heating device 9, and then the heating process was performed in an air atmosphere.

In this Example, to examine a difference in the treatment temperatures, the treatment temperatures T (K) were set to 349 K, 419 K, 489 K, 524 K, 559 K, 629 K, 699 K, 769 K, and 839 K, and the holding time t was set to one hour in each case. The respective treatment temperatures were 0.5 times, 0.6 times, 0.7 times, 0.75 times, 0.8 times, 0.9 times, 1 times, 1.1 times, and 1.2 times the glass transition point T_{g}=699 (K) of a glass material.

In addition, for comparison, an experiment in which the heating was not performed was performed.

Next, in the film forming process S5, the object-to-be-processed after the heating process was taken out from the electric furnace, was set to the lens holder 8 so as to form a film, and was disposed in a vacuum-deposition-type film forming device. In addition, the evacuation for the inside of the film forming device was initiated, and then the heating of the object-to-be-processed was performed. When reaching a predetermined degree of vacuum and a film forming temperature T_{S} of 513 K (240° C.) after 30 minutes, the film formation was initiated. Seven layers of antireflection films were formed in the film forming process S5, and then the object-to-be-processed on which the films were formed was exposed to the air, and the film forming process S5 was terminated.

In this Example, under conditions described above, 160 double-convex lenses were manufactured for each treatment temperature (also including not-heating).

Next, a reflecting property, adhesiveness of the optical thin film, and surface accuracy were evaluated with respect to each of lenses that were manufactured.

The reflectance was measured by a lens reflectance measuring device USPM-RU (trademark; manufactured by Olympus Corporation), and success or failure was determined according to whether or not the reflecting property was within a standard value.

The adhesiveness of the optical thin film was performed by a tape test, and success or failure was determined according to whether or not the adhesiveness was within a reference for peeling-off.

The surface accuracy was measured by a laser interferometer, and success of failure was determined according to whether or not the surface accuracy was within a standard.

For each of these evaluation items, a ratio of the number of accepted products with respect to the number of manufactured products was obtained and this ratio was set as a yield ratio in each of the evaluation items. Evaluation results of this Example are shown in Table 2.

TABLE 2
Example 1

| | Treatment temperature T(K) | | | | | | | | | |
|---|---|---|---|---|---|---|---|---|---|---|
| | Not-heating | 349 | 419 | 489 | 524 | 559 | 629 | 699 | 769 | 839 |
| Treatment | | 76 | 146 | 216 | 251 | 286 | 356 | 426 | 496 | 566 |
| temperature (° C.) | | | | | | | | | | |
| T/T_{g} | — | 0.5 | 0.6 | 0.7 | 0.75 | 0.8 | 0.9 | 1 | 1.1 | 1.2 |
| Reflecting | X | X | Δ | Δ | ◯ | ⊚ | ◯ | ◯ | ◯ | ◯ |
| property | 45/160 | 92/160 | 131/160 | 131/160 | 155/160 | 157/160 | 156/160 | 156/160 | 156/160 | 156/160 |
| Adhesiveness | X | X | Δ | Δ | ◯ | ◯ | ◯ | ◯ | ◯ | ◯ |
| | 58/160 | 92/160 | 116/160 | 125/160 | 152/160 | 154/160 | 155/160 | 156/160 | 156/160 | 156/160 |
| Surface accuracy | ⊚ | ⊚ | ⊚ | ⊚ | ⊚ | ⊚ | ⊚ | ⊚ | Δ | X |
| | 160/160 | 160/160 | 160/160 | 160/160 | 160/160 | 160/160 | 160/160 | 160/160 | 122/160 | 109/160 |
| Overall | X | X | Δ | Δ | ◯ | ◯ | ◯ | ◯ | X | X |
| evaluation | 44/160 | 90/160 | 116/160 | 124/160 | 152/160 | 154/160 | 154/160 | 154/160 | 106/160 | 102/160 |

Here, in Table 2, in regard to the reflecting property, the adhesiveness, and the surface accuracy, values of the yield ratio are shown. ⊚ represents 98% or more, O represents 95% or more and less than 98%, Δ represents 70% or more and less than 95%, and x represents less than 70%. In addition, in an overall evaluation, a case in which all of the yield ratios in three evaluation items are 95% or more is expressed by O, a case in which only a few yield ratios of the three evaluation items are less than 95% is expressed by x. In addition, numerical values shown under each symbol represents “the number of accepted product/the total number of products”.

This expression is true of Tables 3 to 7 described later.

As shown in Table 2, when T/T_{g} is from 0.75 to 1, the yield ratio of each evaluation item was 95% or more and was preferable. On the other hand, at a low-temperature condition (also including not-heating) in which T/T_{g} is less than 0.75, the yield ratio was deteriorated due to the reflecting property and the adhesiveness, and in a high-temperature condition in which T/T_{g} is larger than 1, the yield ratio was deteriorated due to the surface accuracy.

The yield ratio was deteriorated in regard to the reflecting property and the adhesiveness under the low-temperature condition (also including not-heating) in which T/T_{g} is less than 0.75. This deterioration may be caused by a fact that thermal energy during heating process is not sufficient and therefore the modified layer is not sufficiently shrunk.

In addition, the yield ratio is deteriorated in regard to the surface accuracy under the high-temperature condition in which T/T_{g} is larger than 1. This deterioration is because the surface shape of the mirror-finished optical component collapses due to deformation that occurs when the treatment temperature T exceeds the glass transition point T_{g}.

In addition, in this Example, the temperature region in which T/T_{g} is from 0.75 to 1 is a temperature region that is higher than the film forming temperature T_{S} in each case.

### Example 2

As shown in Table 1, this Example 2 is different from Example 1 in that in regard to the shape of the lens, the double-convex lens was substituted with a biconcave lens, and in regard to the atmosphere in the heating process S4, the air atmosphere was substituted with the vacuum atmosphere.

As the shape of the biconcave lens, a shape having a radius of curvature of 150 mm, an outer diameter of 40 mm, an inner diameter of 30 mm, and a central thickness of 15 mm was adopted.

Evaluation results of this Example are shown in Table 3.

TABLE 3
Example 2

| | Treatment temperature T(K) | | | | | | | | | |
|---|---|---|---|---|---|---|---|---|---|---|
| | Not-heating | 349 | 419 | 489 | 524 | 559 | 629 | 699 | 769 | 839 |
| Treatment | | 76 | 146 | 216 | 251 | 286 | 356 | 426 | 496 | 566 |
| temperature (° C.) | | | | | | | | | | |
| T/T_{g} | — | 0.5 | 0.6 | 0.7 | 0.75 | 0.8 | 0.9 | 1 | 1.1 | 1.2 |
| Reflecting | X | X | Δ | Δ | ◯ | ◯ | ⊚ | ⊚ | ⊚ | ⊚ |
| property | 56/160 | 70/160 | 113/160 | 131/160 | 155/160 | 156/160 | 160/160 | 160/160 | 159/160 | 159/160 |
| Adhesiveness | X | X | Δ | Δ | ⊚ | ⊚ | ⊚ | ⊚ | ⊚ | ⊚ |
| | 40/160 | 92/160 | 119/160 | 135/160 | 158/160 | 160/160 | 159/160 | 160/160 | 160/160 | 160/160 |
| Surface accuracy | ⊚ | ⊚ | ⊚ | ⊚ | ⊚ | ⊚ | ⊚ | ⊚ | Δ | X |
| | 160/160 | 160/160 | 160/160 | 160/160 | 160/160 | 160/160 | 160/160 | 159/160 | 125/160 | 100/160 |
| Overall | X | X | X | X | ◯ | ◯ | ⊚ | ⊚ | Δ | X |
| evaluation | 36/160 | 65/160 | 109/160 | 111/160 | 154/160 | 156/160 | 159/160 | 159/160 | 125/160 | 100/160 |

As shown in Table 3, in an overall evaluation, the same results as Example 1 were obtained, but the yield ratio due to the reflecting property in a range in which T/T_{g} is from 0.8 to 1.2, and the yield ratio due to the adhesiveness in a range in which T/T_{g} is from 0.9 to 1.2 were improved compared to the Example 1, respectively. As a result, preferable yield ratios of 98% or more were obtained, respectively.

This improvement is considered to be because the atmosphere in the heating process S4 was set to the vacuum atmosphere, and therefore the pores in the porous layer was shrunk to be further smaller compared to the case of the air atmosphere, and the strength and refractive index of the modified layer were improved to a better state.

### Example 3

As shown in Table 1, this Example 3 is different from Example 1 in that in regard to the shape of the lens, the double-convex lens was substituted with a parallel plate, and in regard to the atmosphere in the heating process S4, the air atmosphere was substituted with the nitrogen atmosphere.

As the shape of the parallel plate, a circular plate shape having a diameter of 30 mm and a plate thickness of 5 mm was adopted.

Evaluation results of this Example are shown in Table 4.

TABLE 4
Example 3

| | Treatment temperature T(K) | | | | | | | | | |
|---|---|---|---|---|---|---|---|---|---|---|
| | Not-heating | 349 | 419 | 489 | 524 | 559 | 629 | 699 | 769 | 839 |
| Treatment | | 76 | 146 | 216 | 251 | 286 | 356 | 426 | 496 | 566 |
| temperature (° C.) | | | | | | | | | | |
| T/T_{g} | — | 0.5 | 0.6 | 0.7 | 0.75 | 0.8 | 0.9 | 1 | 1.1 | 1.2 |
| Reflecting | X | X | Δ | Δ | ◯ | ◯ | ⊚ | ⊚ | ⊚ | ⊚ |
| property | 48/160 | 67/160 | 114/160 | 127/160 | 153/160 | 156/160 | 160/160 | 160/160 | 160/160 | 160/160 |
| Adhesiveness | X | X | Δ | Δ | ◯ | ◯ | ◯ | ◯ | ◯ | ◯ |
| | 50/160 | 65/160 | 117/160 | 124/160 | 152/160 | 154/160 | 155/160 | 156/160 | 154/160 | 156/160 |
| Surface accuracy | ⊚ | ⊚ | ⊚ | ⊚ | ⊚ | ⊚ | ⊚ | ⊚ | Δ | X |
| | 160/160 | 160/160 | 160/160 | 160/160 | 160/160 | 160/160 | 160/160 | 160/160 | 142/160 | 105/160 |
| Overall | X | X | X | X | ◯ | ◯ | ◯ | ◯ | Δ | X |
| evaluation | 37/160 | 40/160 | 101/160 | 110/160 | 150/160 | 153/160 | 155/160 | 156/160 | 136/160 | 102/160 |

As shown in Table 4, in an overall evaluation, the same results as Example 1 were obtained, but as is the case with Example 2, the yield ratio due to the reflecting property in a range in which T/T_{g} is from 0.9 to 1.2 was improved compared to Example 1. As a result, a preferable yield ratio of 98% or more was obtained in each case. However, the yield ratio due to the adhesiveness was the same as Example 1 and was slightly inferior to Example 2.

That is, due to the difference in an atmosphere of the heating process, an intermediate result between Example 1 (air atmosphere) and Example 2 (vacuum) was obtained.

### Example 4

As shown in Table 1, this Example 4 is different from Example 2 in that the nitrogen atmosphere was substituted with a helium atmosphere.

Evaluation results of this Example are shown in Table 5.

TABLE 5
Example 4

| | Treatment temperature T(K) | | | | | | | | | |
|---|---|---|---|---|---|---|---|---|---|---|
| | Not-heating | 349 | 419 | 489 | 524 | 559 | 629 | 699 | 769 | 839 |
| Treatment | | 76 | 146 | 216 | 251 | 286 | 356 | 426 | 496 | 566 |
| temperature (° C.) | | | | | | | | | | |
| T/T_{g} | — | 0.5 | 0.6 | 0.7 | 0.75 | 0.8 | 0.9 | 1 | 1.1 | 1.2 |
| Reflecting | X | X | Δ | Δ | ◯ | ◯ | ⊚ | ⊚ | ⊚ | ⊚ |
| property | 50/160 | 76/160 | 115/160 | 119/160 | 156/160 | 156/160 | 160/160 | 160/160 | 159/160 | 158/160 |
| Adhesiveness | X | X | Δ | Δ | ◯ | ◯ | ⊚ | ⊚ | ⊚ | ⊚ |
| | 55/160 | 68/160 | 117/160 | 121/160 | 154/160 | 156/160 | 160/160 | 160/160 | 160/160 | 160/160 |
| Surface accuracy | ⊚ | ⊚ | ⊚ | ⊚ | ⊚ | ⊚ | ⊚ | ⊚ | Δ | X |
| | 160/160 | 160/160 | 160/160 | 160/160 | 160/160 | 160/160 | 160/160 | 160/160 | 135/160 | 103/160 |
| Overall | X | X | X | X | ⊚ | ⊚ | ⊚ | ⊚ | Δ | X |
| evaluation | 49/160 | 66/160 | 109/160 | 111/160 | 154/160 | 154/160 | 160/160 | 160/160 | 134/160 | 102/160 |

As shown in Table 5, in an overall evaluation, the same results as Example 1 were obtained, but the yield ratio due to the reflecting property and the adhesiveness in a range in which T/T_{g} is from 0.9 to 1.2 were improved compared to Example 1. As a result, a preferable yield ratio of 98% or more was obtained in each case. This result is substantially the same as Example 2.

This is considered to be because in a case where the atmosphere in the heating process S4 is the helium atmosphere, since the molecular weight of helium is low, helium atoms do not hinder the shrinkage of pores in the porous layer and the pores shrink to be small in a ratio that is substantially the same as the vacuum atmosphere.

### Example 5

As shown in Table 1, this Example 5 is different from Example 1 in that fluorophosphate glass was substituted with bismuth-based glass (T_{g}=623(K) (=350° C.)) in which a refractive index is 2.10205 and Abbe number is 16.6, and the cleaning bath 5 was made up by two baths of water-based cleaning baths (pH 8.3) and two layers of rinsing bath using pure water. In addition, the film forming temperature T_{S} was set to 473 K (200° C.) and the antireflective film was formed with six layers.

Evaluation results of this Example are shown in Table 6.

TABLE 6
Example 5

| | Treatment temperature T(K) | | | | | | | | | |
|---|---|---|---|---|---|---|---|---|---|---|
| | Not-heating | 312 | 374 | 436 | 467 | 498 | 561 | 623 | 685 | 748 |
| Treatment | | 39 | 101 | 163 | 194 | 225 | 288 | 350 | 412 | 475 |
| temperature (° C.) | | | | | | | | | | |
| T/T_{g} | — | 0.5 | 0.6 | 0.7 | 0.75 | 0.8 | 0.9 | 1 | 1.1 | 1.2 |
| Reflecting | Δ | Δ | Δ | Δ | ◯ | ◯ | ⊚ | ⊚ | ⊚ | Δ |
| property | 116/160 | 120/160 | 140/160 | 141/160 | 154/160 | 155/160 | 158/160 | 157/160 | 158/160 | 148/160 |
| Adhesiveness | X | X | Δ | Δ | ◯ | ⊚ | ⊚ | ⊚ | ⊚ | ⊚ |
| | 80/160 | 88/160 | 143/160 | 146/160 | 153/160 | 158/160 | 160/160 | 160/160 | 160/160 | 160/160 |
| Surface accuracy | ⊚ | ⊚ | ⊚ | ⊚ | ⊚ | ⊚ | ⊚ | ⊚ | Δ | X |
| | 160/160 | 160/160 | 160/160 | 160/160 | 160/160 | 160/160 | 160/160 | 160/160 | 122/160 | 30/160 |
| Overall | X | X | Δ | Δ | ◯ | ◯ | ⊚ | ⊚ | Δ | X |
| evaluation | 80/160 | 73/160 | 122/160 | 123/160 | 151/160 | 155/160 | 158/160 | 157/160 | 121/160 | 26/160 |

As shown in Table 6, in an overall evaluation of Example 5, results equivalent to or surpassing those in Example 1 were obtained, and therefore it was found that in regard to the glass base material of the object-to-be-processed, the glass containing at least bismuth is effective.

As described above, according to a method of manufacturing the optical component of this embodiment, even when moisture is attached to the surface of the object-to-be-processed that is formed of glass and is mirror-finished, and thereby a modified layer is formed, the modified layer may be restored by the heating process. Therefore, generation of peeling-off of the optical thin film in the optical component that is made up by forming the optical thin film on a glass surface or occurrence of a defect in optical properties of the optical thin film may be suppressed. As a result, a yield ratio of the optical component is improved and thereby productivity of the optical component may be improved.

### Modification Example

Next, a modification example of this embodiment will be described.

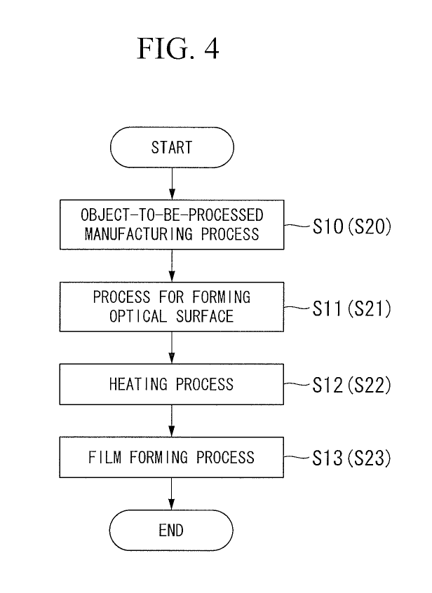

FIG. 4 shows a flowchart illustrating processes of a method of manufacturing an optical component according to a modified example of the first embodiment of the present invention.

In the process for forming optical surface of the first embodiment, the polishing is performed using the polishing agent in which an abrasive is dispersed. In contrast to this, in a method of manufacturing the optical component according to this modified example, the mirror-finishing is performed by a polishing process using a fixed abrasive grain.

That is, as shown in FIG. 4, in this modified example, the lens 1 is manufactured by performing an object-to-be-processed manufacturing process S10, a process for forming optical surface S11, a heating process S12, and a film forming process S13 in this order. Hereinafter, a difference from the first embodiment is mainly described.

The object-to-be-processed manufacturing process S10 is the same process as the object-to-be-processed manufacturing process S1 of the first embodiment.

In the subsequent process for forming optical surface S11, an object-to-be-processed 10 (refer to a section (a) of FIG. 3) is held in a polishing device (not shown) similarly to the first embodiment, and the convex spherical surface 10a is polished, for example, using a fixed abrasive grain grinding stone in which fixed abrasive grains are provided on a surface thereof in a shape corresponding to the lens surface 1a while supplying pure water as a processing liquid to form the lens surface 1a. As the fixed abrasive grain, for example, a diamond abrasive grain may be adopted.

Next, the object-to-be-processed 10 is held by the polishing device in an inverted manner, and the convex spherical surface 10b is polished using the fixed abrasive grain grinding stone corresponding to the lens surface 1b to form the lens surface 1b.

In this manner, the lens main body 1c having the lens surfaces 1a and 1b is formed from the object-to-be-processed 10. Then, the process for forming optical surface S11 is terminated.

The process for forming optical surface S11 is performed using the fixed abrasive grain and polished glass particles are washed out by pure water supplied to the surface of the object-to-be-processed 10 during being polished. When the polishing process is terminated, moisture or the like on the surface is wiped away using a towel or the like, and then lens cleaning is performed.

In this modified example, the cleaning process S3, which was performed with the object-to-be-processed 10 being dipped into the cleaning bath 5 after the process for forming optical surface S11, is omitted. Therefore, compared to the first embodiment, a contact time of the lens main body 1c with water is shortened and therefore the depth of the modified layer may be reduced. However, since in the process for forming optical surface S11, the lens main body 1c comes into contact with water, it cannot be said that the modified layer is no longer generated.

The subsequent heating process S12 and the film forming process S13 are the same processes as the above-mentioned first embodiment of the heating process S4 and the film forming process S5.

By performing these processes, the lens 1 that is substantially the same as that of the first embodiment may be manufactured.

Next, specific operations of the method of manufacturing the optical component of this modification example will be described on the basis of Example 6.

Manufacturing conditions in Example 6 are shown in Table 1 shown above.

### Example 6

In Example 6, an object-to-be-processed of a meniscus lens, which has a shape in which a radius of curvature of the convex surface is 150 mm, a radius of curvature of a concave surface is 100 mm, a diameter is 30 mm, and a central thickness is 8 mm, was manufactured from Si—Ba-based glass (T_{g}=936(K)(=663° C.)) in which a refractive index is 1.60311 and Abbe number is 60.7 as a glass material (an object-to-be-processed manufacturing process S10).

Next, in the process for forming optical surface S11, the object-to-be-processed was polished using a fixed abrasive grain grinding stone containing diamond as an abrasive grain while using pure water as a processing liquid to form the optical mirror surface, and then moisture on the surface was wiped.

Then, the heating process S12 was performed without performing the cleaning process.

In the heating process S12, the object-to-be-processed on which the optical mirror surface was formed was put into the electric furnace that is the heating device 9 and the heating process was performed in a vacuum atmosphere.

In this Example, to examine a difference in the treatment temperatures, the treatment temperatures T(K) were set to 468 K, 562 K, 655 K, 702 K, 749 K, 842 K, 936 K, 1030 K, 1123 K, and the holding time t was set to one hour in each case. The respective treatment temperatures were 0.5 times, 0.6 times, 0.7 times, 0.75 times, 0.8 times, 0.9 times, 1 times, 1.1 times, and 1.2 times the glass transition point T_{g}=936 (K) of a glass material.

In addition, for comparison, an experiment in which the heating was not performed was performed.

That is, this Example is different from Example 1 in the glass material and shape of the object-to-be-processed, and the process for forming optical surface. In addition, this Example is different from Example 1 in that the cleaning process was not performed.

Next, the object-to-be-processed after the heating process was taken out from the electric furnace and then the film formation was performed similarly to Example 1 (film forming process S13). After forming the film, evaluation was performed with respect to each lens.

Evaluation results of this Example are shown in Table 7.

TABLE 7
Example 6

| | Treatment temperature T(K) | | | | | | | | | |
|---|---|---|---|---|---|---|---|---|---|---|
| | Not-heating | 468 | 562 | 655 | 702 | 749 | 842 | 936 | 1030 | 1123 |
| Treatment | | 195 | 289 | 382 | 429 | 476 | 569 | 663 | 757 | 850 |
| temperature (° C.) | | | | | | | | | | |
| T/T_{g} | — | 0.5 | 0.6 | 0.7 | 0.75 | 0.8 | 0.9 | 1 | 1.1 | 1.2 |
| Reflecting | Δ | Δ | Δ | Δ | ◯ | ◯ | ⊚ | ⊚ | ⊚ | ⊚ |
| property | 116/160 | 120/160 | 132/160 | 135/160 | 155/160 | 155/160 | 160/160 | 160/160 | 160/160 | 160/160 |
| Adhesiveness | X | X | Δ | Δ | ◯ | ⊚ | ⊚ | ⊚ | ⊚ | ⊚ |
| | 100/160 | 92/160 | 113/160 | 121/160 | 153/160 | 158/160 | 160/160 | 160/160 | 160/160 | 160/160 |
| Surface accuracy | ⊚ | ⊚ | ⊚ | ⊚ | ⊚ | ⊚ | ⊚ | ⊚ | Δ | X |
| | 160/160 | 160/160 | 160/160 | 160/160 | 160/160 | 160/160 | 160/160 | 160/160 | 122/160 | 30/160 |
| Overall | X | X | X | X | ◯ | ◯ | ⊚ | ⊚ | Δ | X |
| evaluation | 89/160 | 84/160 | 101/160 | 104/160 | 152/160 | 154/160 | 160/160 | 160/160 | 122/160 | 30/160 |

As shown in Table 7, in an overall evaluation, the same results as Example 1 were obtained, but the yield ratios due to the reflecting property and the adhesiveness in a range in which T/T_{g} is from 0.9 to 1.2 were improved compared to the Example 1, respectively. As a result, preferable yield ratios of 98% or more were obtained, respectively. In addition, in regard to the yield ratios due to the reflecting property in a case where the heating was not performed and a case where in which T/T_{g} was 0.5, preferable results compared to Example 1 were obtained.

According to this Example, since the cleaning process is not performed, it is considered that the modified layer is generated only in the process for forming optical surface S11.

According to this Example, it became clear that when the heating is performed by the heating process, the yield ratio of the optical component may be improved even when the cleaning process is not performed.

When observing the yield ratio in a state in which the heating process is insufficient in this Example, it is clear that the modified layer, which has an effect on the reflecting property or the adhesiveness, is generated even in the contact with water in the process for forming optical surface.

Therefore, it is thought that in the Examples 1 to 4, the modified layer is formed due to the contact with water in the process for forming optical surface, and the degree of modification of the modified layer increases due to the contact with water in the cleaning process.

That is, according to Examples 1 to 6, it became clear that when the heating process of the present invention is performed, the modified layer generated in the process for forming optical surface and the modified layer generated in the cleaning process may be improved and therefore the yield ratio of the optical component may be improved.

When considering the process for forming optical surface S11 of this modified example, a mechanism in which components are eluted into pure water that is a processing liquid and therefore the modified layer is formed is the same as the process for forming optical surface S2 of the first embodiment. However, in this Example, since pure water was used in the process for forming optical surface S11, fine cracks, which are generated on the optical component surface due to the processing using the grinding stone, were extended. This may also be exemplified as a cause of deteriorating the reflecting property or adhesiveness.

On the surface of the object-to-be-processed, fine cracks are generated due to large stress during the object-to-be-processed manufacturing process S10 or the removal process in the process for forming optical surface S11. In a case where these cracks are extended when being etched by being brought into contact with water, fine cracks remain on the surface after being polished, and therefore the adhesiveness of the optical thin film is deteriorated in the vicinity of the cracks. Due to this, the peeling-off of a film may occur easily.

Since the heating process of the present invention has an effect of repairing or removing the extended cracks, it is considered that the adhesiveness may be improved together with the reflecting property.

### Second Embodiment

Next, a description will be made with respect to a method of manufacturing an optical component according to a second embodiment of the present invention.

FIG. 4 shows a flowchart illustrating processes of the method of manufacturing the optical component according to the modified example of the first embodiment of the present invention, but processes in the method of manufacturing the optical component according to the second embodiment of the present invention will be described also using FIG. 4.

In the process for forming optical surface of the first embodiment, the polishing is performed using the polishing agent in which an abrasive is dispersed. In contrast to this, in the method of manufacturing the optical component of this embodiment, the process for forming optical surface is performed by transferring a shape of a mold surface to the object-to-be-processed by a press molding (glass molding). Accompanying this, the cleaning process is omitted.

Therefore, in this embodiment, a process sequence is the same as the modified example of the first embodiment, and as shown in FIG. 4, an object-to-be-processed manufacturing process S20, a process for forming optical surface S21, a heating process S22, and a film forming process S23 are performed in this order to manufacture the lens 1. Hereinafter, a difference from the above-described first embodiment will be mainly described.

As shown in a section (a) of FIG. 3, the object-to-be-processed manufacturing process S20 is a process of manufacturing an object-to-be-processed 13 that has an approximate shape of the lens main body 1c of the lens 1.

In addition, in this embodiment, since the mirror-finishing is performed by the press molding, the shape of the object-to-be-processed 13 is not limited as long as the shape of the lens main body 1c may be formed by the press molding. For example, the shape may be a ball shape or a flat plate shape.

As a method of manufacturing the object-to-be-processed 13, a method in which glass base material is processed in advance into the ball shape, the flat plate shape, a lens-approximate shape of the lens main body 1c, or the like by polishing processing, and the object-to-be-processed 13 is manufactured as a so-called glass preform, or a method in which the object-to-be-processed 13 is manufactured as a glass gob that may be obtained through hot-molding may be exemplified.

The subsequent process for forming optical surface S21 is a process of forming the shape of the lens surfaces 1a and 1b and the optical mirror surface by press-molding the object-to-be-processed 13.

That is, although not particularly shown, the object-to-be-processed 13 is disposed in the mold, and the mold is pressed by an appropriate molding device while being heated at a temperature higher than the glass transition point T_{g} of the glass base material to press and deform the object-to-be-processed 13 in the mold, and thereby the surface shape of the mold surface is transferred to the object-to-be-processed 13. When the shape of the mold surface is transferred to the surface of the object-to-be-processed 13, the mold is gradually cooled, and the lens main body 1c that is press-molded is taken out from the molding device. Then, the process for forming optical surface S21 is terminated.

In this process, since the object-to-be-processed 13 is heated in a temperature higher than the glass transition point T_{g} and is pressed, even when the object-to-be-processed 13 comes into contact with water before the mirror-finishing and thereby the modified layer is formed, this modified layer is removed.

The subsequent heating process S22 and the film forming process S23 are the same processes as the first heating process S4 and the film forming process S5 of the first embodiment.

By performing these processes, the lens 1 that is substantially the same as that of the first embodiment may be manufactured.

According to this embodiment, even when the modified layer is previously formed, this modified layer is removed at the time of the mirror-finishing, and water or moisture is not used at the time of the mirror-finishing, such that the modified layer is not newly formed. However, while the object-to-be-processed 13 is taken out from the molding device and is conveyed to the film forming device, or while the object-to-be-processed 13 is stored until the film forming process S23 is performed, the object-to-be-processed 13 may come into contact with moisture in an ambient atmosphere or the like. As a result, the modified layer may be generated on the optical mirror surface.

According to this embodiment, since the film forming process S23 is performed after performing the heating process S22, even when the modified layer is generated on the optical mirror surface between the process for forming optical surface S21 and the heating process S22, the modified layer may be restored. As a result, similarly to the first embodiment, the yield ratio of the optical component is improved and the productivity of the optical component may be improved.

In the first embodiment, a description was made with respect to a case in which after the heating process is performed at the outside of the film forming chamber of the film forming device, the object-to-be-processed that is heated is introduced in the film forming chamber as an example. However, in a case where an adverse effect is not applied to constituent members of the film forming device, the heating may be performed in the film forming chamber of the film forming device. In this case, since the film forming process may be performed without moving the object-to-be-processed after being heated, the contamination of the optical mirror surface or the generation of the modified layer may be reliably prevented.

In the first embodiment, a description was made with respect to a case in which after all of the optical mirror surfaces of the object-to-be-processed are formed, the heating process is performed as an example. However, in a case where the cleaning process is performed whenever one optical mirror surface is formed, the heating process may be performed after the cleaning process in each case. In this case, since the modified layer of the optical mirror surface that is previously formed may be restored, deterioration of the modified layer of the optical mirror surface that is previously formed may be reduced by being subjected to a cleaning process two times.

All of the constituent elements, which are described in each of the above-described embodiments, and the modification example, may be executed by appropriately substituting composition thereof or by appropriately deleting the constituent elements without departing from the technical spirit of the present invention.

Furthermore, while preferred embodiments of the present invention have been described, the present invention is not limited to the embodiments. Additions, omissions, substitutions, and other variations may be made to the present invention without departing from the spirit and scope of the present invention. The present invention is not limited by the above description, but by the appended claims.

1. A method of manufacturing an optical component, comprising:
a process for forming optical surface of mirror-finishing a surface of an object-to-be-processed that is formed of glass;
a heating process of heating the object-to-be-processed that is mirror-finished;
a film forming process of forming an optical thin film on the surface of the object-to-be-processed that is heated in the heating process; and
a cleaning process of cleaning the object-to-be-processed by a water-based cleaning solution between the process for forming optical surface and the heating process,
wherein in the heating process, a first temperature of the object-to-be-processed is from 0.75 times or more to 1 times or less of a glass transition point T_{g} (K) of the object-to-be-processed.

2. The method of manufacturing an optical component according to claim 1,
wherein in the heating process, the object-to-be-processed is heated so that the first temperature of the object-to-be-processed is higher than a second temperature of the object-to-be-processed in the film forming process.

3. The method of manufacturing an optical component according to claim 1 or 2,
wherein in the heating process, the object-to-be-processed is heated in vacuum.

4. The method of manufacturing an optical component according claim 1 or 2,
wherein in the heating process, the object-to-be-processed is heated in inert gas.

5. The method of manufacturing an optical component according to claim 4,
wherein the inert gas is helium.

6. The method of manufacturing an optical component according to claim 1 or 2,
wherein the heating process is performed in a heating chamber that is provided separately from a film forming chamber in which the film forming process is performed.

7. The method of manufacturing an optical component according to claim 1 or 2,
wherein the object-to-be-processed is formed of an optical glass containing at least fluorine.

8. The method of manufacturing an optical component according to claim 1 or 2,
wherein the object-to-be-processed is formed of an optical glass containing at least phosphorus.

9. The method of manufacturing an optical component according claim 1 or 2,
wherein the object-to-be-processed is formed of an optical glass containing at least bismuth.
